(19) United States
(12) Patent Application Publication
(10) Pub. No.: US 2010/0327022 A1
(43) Pub. Date: Dec. 30, 2010

(54) DISPENSER SYSTEM AND METHOD

(75) Inventor: Rinely M. Deeds, Felton, CA (US)

Correspondence Address: Diversey, Inc., 8310 16TH STREET, M/S 509, PO BOX 902, STURTEVANT, WI, 53177-0902, US

(73) Assignee: DIVERSEY, INC., Sturtevant, WI (US)

(21) Appl. No.: 12/677,056

(22) PCT Filed: Sep. 5, 2008
(86) PCT No.: PCT/US08/75399

§ 371 Date: Mar. 8, 2010

Related U.S. Application Data
(60) Provisional application No. 60/971,458, filed on Sep. 11, 2007.

(51) Int. Cl. B67D 7/84

(52) U.S. Cl. 222/325; 222/173; 222/557

(57) ABSTRACT

A dispensing system for dispensing material from a container having an opening secured by a cap through which material from the container is dispensed. The dispensing system comprises a dispenser defining a receptacle shaped to receive the container and a retainer releasably engagable with the cap, wherein the retainer is engagable with the cap via a releasable and resiliently deformable connection providing resistance against withdrawal of the container from the receptacle. In some embodiments, an aperture defined in the retainer is shaped and dimensioned to receive a portion of the cap. In some embodiments, a portion of the retainer is resiliently deformable, and at least partially defines the resiliently deformable connection. In some embodiments, the portion of the retainer is a protrusion extending in a direction toward the receptacle. In some embodiments, the releasable and resiliently deformable connection provides a snap fit engagement between the retainer and the cap.

### BACKGROUND OF THE INVENTION

As washing machines (e.g. dish washing machines, clothes washing machines, etc.) have become more sophisticated, systems have been implemented to automatically feed such machines with detergents, sanitizers, and/or rinse aids found in liquid, condensed, compressed, granulated, and/or powdered form. Such materials may be automatically delivered to a variety of types of washing machines.

### SUMMARY

Some embodiments of the present application relate to a dispensing system for dispensing material from a container having an opening secured by a cap through which material from the container is dispensed. The dispensing system comprises a dispenser defining a receptacle shaped to receive the container and a retainer releasably engagable with the cap, wherein the retainer is engagable with the cap via a releasable and resiliently deformable connection providing resistance against withdrawal of the container from the receptacle. In some embodiments, an aperture defined in the retainer is shaped and dimensioned to receive a portion of the cap. In some embodiments, a portion of the retainer is resiliently deformable, and at least partially defines the resiliently deformable connection. In some embodiments, the portion of the retainer is a protrusion extending in a direction toward the receptacle. In some embodiments, the releasable and resiliently deformable connection provides a snap fit engagement between the retainer and the cap.

### BRIEF DESCRIPTION OF THE DRAWINGS

FIG. 1 illustrates a dispenser system according to an embodiment of the present invention.

FIG. 2 illustrates various views of the dispensing closure and retainer shown in FIG. 1.

FIG. 3 illustrates various views of the retainer shown in FIGS. 1 and 2.

FIG. 4 illustrates a sectional view of the dispensing closure and retainer shown in FIGS. 1-3.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

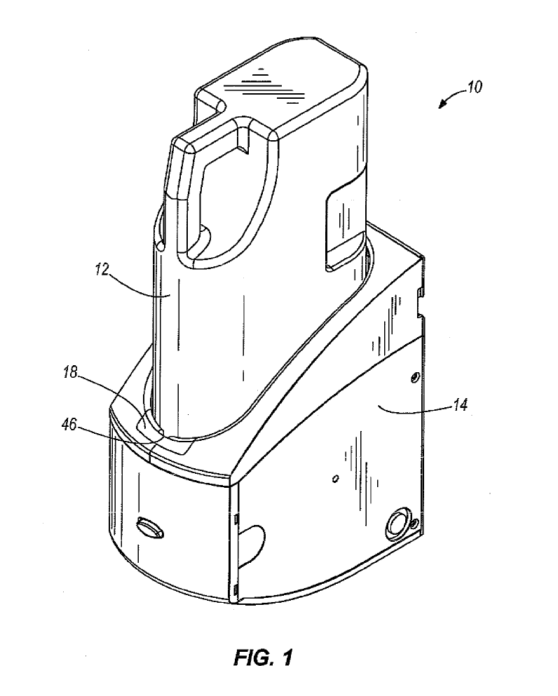

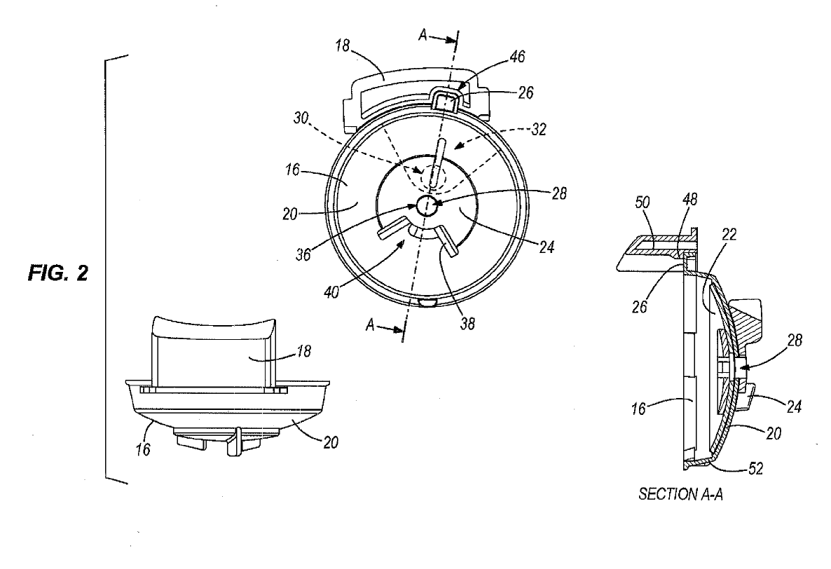

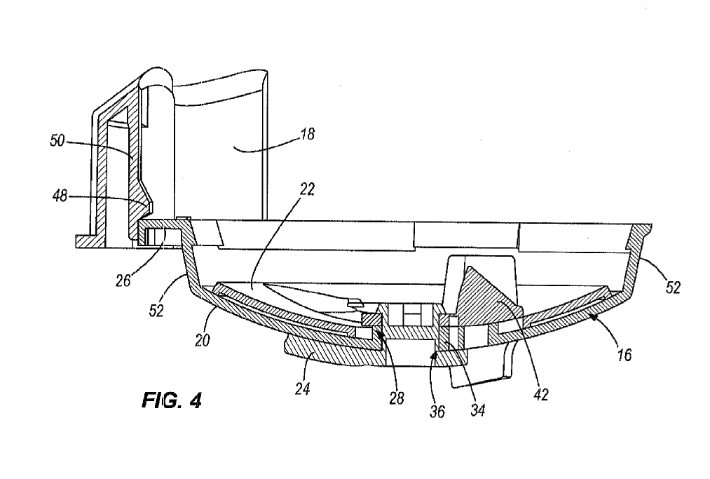

FIG. 1 illustrates a dispenser system 10 according to an embodiment of the present invention. The illustrated system includes a container 12 (shown only in FIG. 1), a receptacle 14 (also shown only in FIG. 1), a dispensing closure 16 (FIGS. 2 and 4), and a retainer 18, any or all of which can comprise plastic, metal, or other suitable material. By way of example only, the retainer 18 illustrated in FIGS. 1-4 comprises injection-molded polypropylene. The container 12 houses a flowable cleaning material (e.g., a chemical such as a detergent, a sanitizer, a rinse aid, and the like). The flowable cleaning material can take a number of different forms, including without powder, granular, liquid, or other flowable forms. In other embodiments, the cleaning material within the container 12 can take still other forms, such as block or other compacted forms. In operation, the illustrated container 12 and attached dispensing closure 16 are supported by the receptacle 14 in a position where the dispensing closure 16 is capable of engaging a drive system (not shown). Water is introduced into the receptacle 14 through a water intake conduit. Although not shown in the accompanying figures, a drive member generates rotation of a drive shaft and transfers motion to the drive system, which engages the dispensing closure 16 to dispense the cleaning material. It should be noted that any number of different drive systems can be used to dispense cleaning material from the container 12, and can be driven by a variety of different motors or other prime movers known to those skilled in the art. Examples of such drive systems are disclosed in U.S. patent application Ser. No. 11/670,158 filed on Feb. 1, 2007, the entire contents of which are incorporated herein by reference insofar as they relate to dispenser drive systems and their manner of operation.

Referring now to FIG. 2, the illustrated dispensing closure 16 has three main components: a cap 20, a first rotating portion 22 and a second rotating portion 24. The cap 20 shown in FIGS. 2 and 4 includes an key 26, a drive opening 28 and a measuring opening 30 (shown only in FIG. 2 in dotted lines). In some embodiments, the first rotating portion 22 moves to clear the measuring opening 30 of the cap 20. The first rotating portion 22 can also have a cutaway portion 32 (located on the opposite side of the cap 20 in the first view of FIG. 2, and therefore shown in dotted lines therein). The cutaway portion 32 defines a space in which cleaning material can be collected. An axially-extending shaft 34 extends between and drivably connects the first and second rotating portions 22, 24. The second rotating portion 24 shown in FIGS. 2 and 4 includes a drive opening 36, a portion 38 (e.g., front edge) for cleaning material removal, and a cutaway portion 40 for allotment of a space for cleaning material release toward the dispensing closure 16. When the first rotating portion 22, the second rotating portion 24, and dispensing closure 16 are properly aligned by the shaft 34 extending through the drive openings 28, 36, cleaning material from the container 12 is free to enter into the measuring opening 30 as the measuring opening 30 is uncovered by the first rotating portion 22. However, when the measuring opening 30 is exposed for receiving cleaning material in one or more positions of the first rotating portion 22, the cleaning material cannot immediately pass into the receptacle 14, such passage is blocked by the second rotating portion 24.

The coupled portions 22, 24 of the illustrated embodiment allow for a predetermined dose of flowable cleaning material to collect in the measuring opening 30 of the cap 20 when the cutaway portion 32 of the first rotating portion 22 is rotated to expose the measuring opening 30. A dose of cleaning material enters the measuring opening 30 and is retained in the measuring opening 30 by second rotating portion 24. A driving member (not shown) rotates a drive shaft and drive system (also not shown), thereby transferring motion to the coupled portions 22, 24 and causing the first rotating portion 22 to cover the measuring opening 30. Upon further rotation, the second rotating portion 24 exposes the measuring opening 30 to allow delivery of the predetermined dose of cleaning material. At the same time as this cleaning material delivery, the first rotating portion 22 blocks entry of additional cleaning material into the measuring opening 30. When the front edge 38 of the second rotating portion 24 reaches the measuring opening 30, the front edge 38 (in combination with optional resiliently deformable arms 42 of the cap 20) remove any remaining cleaning material.

The dispensing process described above repeats as the cutaway portion 32 of the first rotating portion 22 moves further to expose the measuring opening 30, thereby allowing another dose of cleaning material to collect within the measuring opening 30. In some embodiments, multiple doses are delivered during a single delivery cycle. Further information regarding these and other types of dispensing closures is found in U.S. patent application Ser. No. 11/670,158 filed on Feb. 1, 2007, the entire contents of which are incorporated herein by reference insofar as they relate to dispensing closures and their manner of operation.

Referring to FIGS. 2-4, the illustrated retainer 18 has an aperture 46 defined therein, and a receptacle flange 44 extending radially outwardly for engagement with an interior wall (not shown) of the receptacle 14. In some embodiments, the aperture 46 is shaped and positioned to receive the key 26 of the dispensing closure 16. The aperture 46 of the retainer 18 may be various shapes, such as elongated, round and rectangular. The location, size, and/or shape of the aperture 46 can be selected to enable only dispensing closure devices with an appropriately positioned, sized, and shaped key 26 to be received within the receptacle 14 (thereby enabling proper engagement with the drive system to dispense cleaning material therethrough). Also, in some embodiments, the retainer 18 has two or more apertures 46 located in any desired positions along the retainer 18, and/or the dispensing closure 16 has two or more keys 26 located in any desired positions along the dispensing closure 16. The aperture(s) 48 and the key(s) 26 can be positioned, sized, and shaped to enable one or more retainers 18 to engage one or more dispensing closures 16, and also to prevent one or more dispensing closures 16 from being engaged with one or more retainers 18. In this manner, a dispensing system 10 in which a particular retainer 18 is installed can receive certain dispensing closures 16 corresponding to particular types of containers 12 carrying particular types of chemicals, while preventing accidental or intentional installation of other dispensing closures 16 corresponding to other containers 12 carrying other types of chemicals. Further information regarding these and other types of dispensing closure-to-dispenser connections is found in U.S. patent application Ser. No. 11/670,158 filed on Feb. 1, 2007, the entire contents of which are incorporated herein by reference insofar as they relate to dispensing closure-to-dispenser connections and their manner of operation.

As shown in FIGS. 2-4, the key 26 of the dispensing closure 16 is a protrusion mating with the aperture 46 in the retainer 18. However, it will be appreciated that this male-female engagement can be reversed in other embodiments. For example, the dispensing closure 16 can instead or also have one or more apertures 46 for receiving one or more protrusions (i.e., keys 26) on the retainer 18.

With continued reference to the embodiment of FIGS. 1-4, in order to insert the container 12 into the receptacle 14 for dispensing chemicals from the container 12, the key 26 and aperture 46 of these parts 12, 14 must first be aligned as to allow the key 26 to be guided into the aperture 46, as shown in FIG. 2. The configuration of the dispensing closure 16 and the receptacle 14 are such that key 26 and aperture 46 must be aligned upon insertion. This alignment permits insertion of the container 12 by applying a downward force.

In some embodiments, the retainer 18 is shaped to resist movement of the dispensing closure 16 (and therefore, the container 12) in a direction away from the receptacle 14. Such movement could otherwise result in partial or full disengagement of the drive shaft and drive system from the dispensing closure 16. In some embodiments, it is desirable to permit removal of the dispensing closure 16 and container 12 from the receptacle 14 by a user, but to still provide sufficient resistance to partial or full disengagement (as described above) resulting from drive system vibration, movement of the drive shaft or drive system, or other forces.

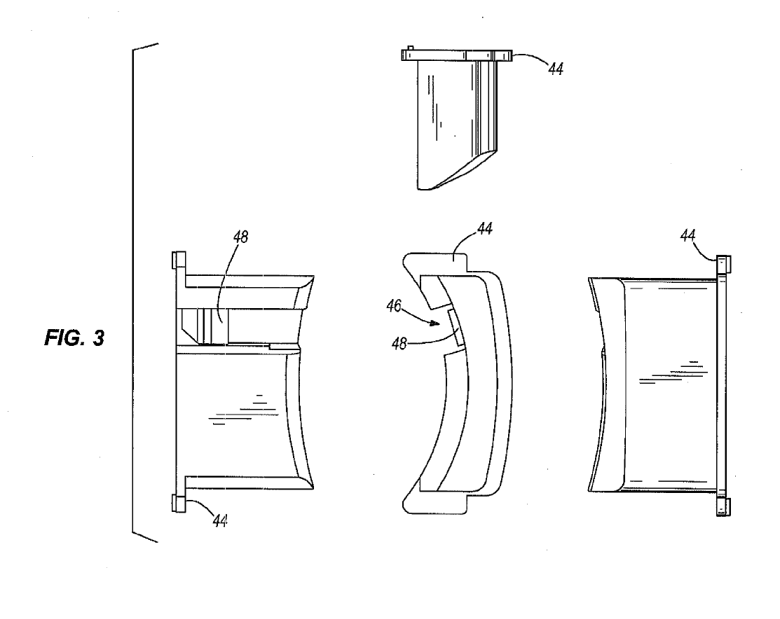

To this end, the retainer 18 shown in FIGS. 1-4 includes a protrusion 48 (FIGS. 2-4) that resiliently engages with the key 26 of the dispensing closure 16 as the dispensing closure 16 is inserted into the receptacle 14. The protrusion 48 in the illustrated embodiment extends radially inwardly (and therefore, toward a dispensing closure 16 within the receptacle 14), and engages the key 26 as the key 26 is received within the aperture 46 of the retainer 18. In some embodiments, the resilient engagement described above is provided by resilient deformation of a wall on which the protrusion 48 is located or by a wall defining the protrusion 48. For example, and with reference to FIG. 4, the protrusion 48 is defined by a wall 50 of the retainer 18 that can move radially outwardly as the protrusion 48 engages the key 26 (as the dispensing closure 16 is inserted into the receptacle 14). After passing the protrusion 48 in installation of the dispensing closure 16, the wall 50 can fully or partially return to a relaxed state, thereby providing a degree of resistance to withdrawal of the key 26 from the aperture 46. Any degree of resistance can be selected based at least in part upon the size and location of the protrusion 48, the shape of the protrusion 48 (e.g., beveled edges in the illustrated embodiment), the size, location, and shape of the key 26, and/or the material of the retainer wall providing the resilient deformation described above. For example, for a greater amount of resistance to protrusion movement in the illustrated embodiment, the width or length of the protrusion (see FIG. 3) can be increased.

In operation, the key 26 shown in FIGS. 2 and 4 is inserted into the aperture 46 of the retainer 18 as the dispensing closure 16 is inserted into the receptacle 14. Upon engagement of the key 26 with the protrusion, further force applied to insert the dispensing closure 16 into the receptacle 14 is at least partially applied to the protrusion 48, causing the wall 50 of the retainer 18 to deflect until the key 26 passes the protrusion. Thereafter, the key 26 is retained in the aperture 46 by the protrusion 48 until a force sufficient to deflect the wall 50 again is applied (e.g., by a user pulling the container 12 in a withdrawing direction with sufficient force). This “snap-fit” engagement between the retainer 18 and the dispensing closure 16 can also provide audible and/or physical confirmation that the dispensing closure 16 has been properly inserted, and that drive system operation can begin to dispense cleaning material from the container 12.

As described above, unintentional or accidental disengagement of the dispensing closure 16 can be prevented by resilient engagement between the protrusion 48 on the retainer 18 and the key 26 on the dispensing closure 16. Although this resilient engagement is provided in the illustrated embodiment by a resiliently deformable portion (e.g., wall 50) of the dispensing closure 16, this engagement can be provided in a number of other manners falling within the spirit and scope of the present invention. For example, the protrusion 48 can comprise a resiliently deformable material such as urethane, neoprene or other plastic materials, synthetic or natural rubber, and the like. This type of protrusion 48 can deform upon engagement and/or passage of the key 26, and can at least partially return to its original shape or provide a biasing force to prevent accidental or unintentional disengagement of the dispensing closure 16. In such embodiments, the protrusion 48 can be located on a portion of the retainer 18 that does not deflect or otherwise move upon insertion of the dispensing closure 16, or can be located on such a portion of the retainer 18 as described above.

As another example, the protrusion 48 can instead be located on the dispensing closure 16, such as on the key 26 or on any other portion 52 (e.g., peripheral edge) of the dispensing closure 16. In such embodiments, the protrusion 48 can engage another protrusion of the type described above, or another feature of the retainer 18. Also in such embodiments, the protrusion can resiliently deform to permit insertion of the dispensing closure 16 and/or can be located on the key 26 or other portion of the dispensing closure 16 that resiliently deforms to permit insertion of the dispensing closure 16.

In further embodiments, the protrusion extending from either the retainer 18 or the dispensing closure 16 is movable about a pivot of a respective surface of the retainer 18 or the dispensing closure 16. The protrusion can resiliently deform and/or hinge against a biasing force to permit insertion of the dispensing closure 16.

Although only a single protrusion is shown in the illustrated embodiment of FIGS. 1-4, it should be noted that any number of protrusion can be utilized to provide the resilient engagement described above. Also, one or more protrusions can be located on both the retainer 18 and the dispensing closure 16 for such resilient engagement.

It should also be noted that in any of the embodiments described and illustrated herein, the protrusion employed for retention of the dispensing closure 16, the element on which the protrusion is located, and/or the element which engages the protrusion can resiliently deform to provide the same desired degree of retaining force described above while still falling within the spirit and scope of the present invention. In these and still other embodiments, a separate element is used to provide resilient engagement between the dispensing closure 16 and the retainer 18. This separate element can provide a biasing force upon the dispensing closure 16, such as upon the key 26 or on another portion of the dispensing closure 16. For example, the retainer 18 or the dispensing closure 16 can be provided with a spring-loaded ball detent resiliently engaging the dispensing closure 16 or the retainer 18, respectively, as the dispensing closure 16 is inserted into the receptacle 14. As another example, the dispensing closure 16 can be fitted with a full or partial O-ring, and/or the retainer 18 can be fitted with part of an O-ring. In such embodiments, the O-ring(s) can deform upon engagement with a passing portion of the dispensing closure 16 or retainer 18, thereby providing a degree of resistance to later withdrawal of the dispensing closure 16. The O-ring(s) can be received within grooves, slots, or other suitable features on the dispensing closure 16 and/or retainer 18 onto which they are fitted, can be retained in place by suitable adhesive or cohesive bonding materials, mechanical fasteners, or in any other manner.

As yet another example, one or more magnets can be located on the dispensing closure 16 and/or on the retainer 18 to provide a biasing force with respect to another magnet on the retainer 18 and/or dispensing closure 16, respectively, or with respect to a material responsive to such magnet(s) on or of the retainer 18 and/or dispensing closure 16, respectively. In such embodiments, the magnet(s) can be positioned to exert a biasing force resisting accidental or unintentional withdrawal of the dispensing closure 16 from the receptacle 14.

Other biasing elements or structures can be utilized to retain the dispensing closure 16 in proper engagement position within the receptacle 14. For example, a pawl and ratchet device can be defined by or otherwise located between the dispensing closure 16 and retainer 18, and can freely permit movement of the dispensing closure 16 in one (i.e., insertion) direction, which preventing movement in an opposite direction without user manipulation of the pawl. Still other biasing elements and structures exist, and fall within the spirit and scope of the present invention.

The first rotating portion 22 and second rotating portion 24 of the illustrated dispensing closure 16 are operated by engagement of a drive shaft within either or both drive openings 28, 36 of the first and second rotating portions 22, 24. In other embodiments, however, the first rotating portion 22 and second rotating portion 24 can be driven in other manners, including without limitation by a drive system engaging a fin extending from the first rotating portion 22 or second rotating portion 24, by engagement between a drive system and a peripheral edge of the first rotating portion 22 and/or second rotating portion 24, and the like.

Still further embodiments of dispenser system 10 according to the present invention exist. For example, a dispenser system 10 having any of the features described above can receive two containers carrying the same or different chemicals. In some embodiments, the separate containers are utilized to introduce separate cleaning materials (e.g., a sanitizer and a detergent) or chemicals in any other form to a water supply. Also, it should be noted that the dispenser system 10 described with respect to FIGS. 1-4 is provided as an exemplary system only. Furthermore, the control method described above may be applied to a variety of dispenser systems. For example, in other embodiments, a dispenser system need not include a receptacle 14 that contains water. An alternative dispenser system may utilize a separate portion that allows a cleaning material to be dropped into an additional container having a liquid predisposed therein. Additionally or alternatively, other liquids such as water miscible and immiscible solvents including water and ether could be employed in a dispenser system.

The illustrated dispensing closure 16 discloses only a single type of delivery device. The present invention can be used in conjunction with any type of dispensing device, such as devices having only one rotatable portion, devices that dispense in a non-rotating method, devices that are not necessarily metered for cleaning material dispensing, and the like.

Although the invention has been described in detail with reference to certain preferred embodiments, variations and modifications exist within the spirit and scope of one or more independent aspects of the present invention.

What is claimed:

1. A dispensing system for dispensing material from a container having an opening secured by a cap through which material from the container is dispensed, the dispensing system comprising:
a dispenser defining a receptacle shaped to receive the container;
a retainer releasably engagable with the cap, wherein the retainer is engagable with the cap via a releasable and resiliently deformable connection providing resistance against withdrawal of the container from the receptacle.

2. The dispensing system of claim 1, wherein an aperture defined in the retainer is shaped and dimensioned to receive a portion of the cap.

3. The dispensing system of claim 1, wherein a portion of the retainer is resiliently deformable, and at least partially defines the resiliently deformable connection.

4. The dispensing system of claim 1, wherein the portion of the retainer is a protrusion extending in a direction toward the receptacle.

5. The dispensing system of claim 1, wherein the releasable and resiliently deformable connection provides a snap fit engagement between the retainer and the cap.
